(19) United States
(12) Patent Application Publication
(10) Pub. No.: US 2014/0013963 A1
(43) Pub. Date: Jan. 16, 2014

(54) STEAM COOKING APPLIANCE, IN PARTICULAR A STEAM OVEN

(71) Applicants: Olivier Hoffmann, Molsheim (FR); Radwane Oumghari, Illkirch (FR); Matthieu Schneider, Haguenau (FR)

(72) Inventors: Olivier Hoffmann, Molsheim (FR); Radwane Oumghari, Illkirch (FR); Matthieu Schneider, Haguenau (FR)

(73) Assignee: BSH BOSCH UND SIEMENS HAUSGERÄTE GMBH, Munich (DE)

(21) Appl. No.: 14/008,029

(22) PCT Filed: Apr. 10, 2012
(86) PCT No.: PCT/EP2012/056432

§ 371 Date: Sep. 27, 2013

(30) Foreign Application Priority Data
May 14, 2011 (EP) 11290209.3

(51) Int. Cl. A47J 27/04

(52) U.S. Cl. CPC A47J 27/04
USPC 99/403

(57) ABSTRACT

A steam cooking appliance includes side walls defining a cooking space. At least one of the side walls has at least one overflow opening which is connected to an overflow line that branches into an overflow drain and a steam exhaust tube. At least one steam valve is provided on the steam exhaust tube and configured to change, at least temporarily, a cross section of the steam exhaust tube.

The invention relates to a steam cooking appliance, in particular a steam oven.

Steam cooking appliances, such as steam ovens for example, are used to cook food by means of steam. Such a cooking appliance is known for example from EP 023353 A2. This appliance has a closed cooking space. Supported on the rear wall is a blade wheel, which is enclosed by an electric heating coil. Water from a water supply line is evaporated by the blade wheel by way of the heating coil. A condensed water drain is located at the lowest point of the cooking space.

Steam cooking appliances of this type are generally operated as follows. If steam is to be produced in the cooking space, the cooking space must be closed, with the result that a certain overpressure is produced in the cooking space. A lock is generally provided on the cooking space and is closed in the state in which steam is to be produced. In this state steam can only escape from the cooking space by way of an overflow opening. Such overflow openings are provided in order to ensure that condensed water can still be removed reliably from the cooking space even if the condensed water drain is blocked for example. The steam escaping by way of said overflow opening must pass through a water tank, to which the overflow line connected to the overflow opening leads, before it can escape from the steam cooking appliance by way of a steam chimney.

In the state in which cooking is to take place without steam or to regenerate the air in the cooking space however there must be a ventilation opening for fresh air to the cooking space. The ventilation opening or fresh air opening is generally provided on the upper face of the cooking space and is closed off as far as possible by a metal plate that can be raised as required.

Such a cooking appliance has the disadvantage that it is not possible to control or regulate the setting of a desired pressure in the cooking space specifically.

The object of the present invention is therefore to create a steam cooking appliance which eliminates this disadvantage at least.

According to the invention therefore the object is achieved by a steam cooking appliance, in particular a steam oven, having a cooking space, which has at least one overflow opening in at least one of the side walls. The cooking appliance is characterized in that the overflow opening is connected to an overflow line, which branches into an overflow drain and a steam exhaust tube and at least one steam valve is provided on the steam exhaust tube, by means of which the cross section of the steam exhaust tube can be changed at least temporarily.

In the context of the present invention a steam cooking appliance preferably refers to a steam oven. This includes steam ovens that have a steam generator outside the cooking space as well as steam ovens in which the steam is produced in the cooking space. The latter type of steam oven includes appliances, in which the water for steam production is conducted into the cooking space by way of a water supply line, as well as appliances, in which the cooking space floor serves as a water reservoir. In the case of appliances in which the floor serves as a water reservoir, said floor is closed. In the case of the other appliance variants a water drain opening is preferably provided in the floor, by way of which condensed water can exit from the cooking space and which is also referred to as a siphon.

In the inventive steam cooking appliance the cooking space is preferably delimited by a so-called cooking space muffle or oven muffle and by an oven door at the front. The vertical walls of the cooking space, in particular of the cooking space muffle, are referred to here as side walls, one of the side walls therefore forming the rear wall of the cooking space.

The overflow opening is disposed in the at least one side wall in such a manner that its distance from the floor of the cooking space corresponds to the maximum permissible or desired water level on the floor. The overflow opening is therefore located in the lower region of the side wall of the cooking space, in particular of the oven muffle.

The overflow line, which connects to the overflow line according to the invention, can be a tube or hose. Because the overflow line branches, the overflow line can be used for various functions in the inventive steam cooking appliance. Water that is above the maximum water level in the cooking space, in particular on the floor, can pass by way of the overflow line to the overflow drain. The overflow drain can be a tube or hose for example, through which the water flows away in a downward direction. As a steam exhaust tube is also provided at the branching point, steam can also be removed or escape from the cooking space specifically through the overflow opening.

As with the invention the steam, which is to be removed from the cooking space, passes directly from the overflow line into the steam exhaust tube, the steam is not countered by any pressure. In contrast in the prior art, in which the steam can only escape by way of a water tank, there must be sufficient pressure in the cooking space to conduct the steam into the water tank and beyond into the steam chimney counter to the counterpressure of the water. It is thus also possible with the inventive steam cooking appliance to release steam from the cooking space when the overpressure in the cooking space is low or there is no overpressure.

A steam valve is provided in the steam exhaust tube to regulate the steam exhaust, in other words to regulate the flow of steam in the steam exhaust tube.

Within the context of the present invention a steam valve refers to an apparatus by means of which the steam flow in the steam exhaust tube can be regulated. The steam valve is designed in such a manner that the cross section of the steam exhaust tube can be changed at least temporarily. A change to the cross section preferably means a reduction of the cross sectional area of the steam exhaust tube. This reduces the throughflow area or throughflow cross section, by way of which steam can flow through the steam exhaust tube, at least in the region of the steam valve. This allows the quantity of steam that can exit from the cooking space to be regulated. In contrast to flaps or plates, with which there is no change to the cross section but an opening and closing of the tube end or another opening, with the inventively used type of steam valve it is possible to regulate the steam exhaust specifically in a reliable manner.

The present invention therefore combines the displacement of the steam exhaust to a point that can be reached by the steam without counterpressure and is at a distance from the cooking space. This means that in contrast to a steam exhaust on the cooking space, for example by means of a plate that can be raised, it is possible to position a steam valve on the steam exhaust in a simple manner, thereby allowing regulation of the steam flow or quantity of steam, which is to be removed from the cooking space.

According to one preferred embodiment the steam valve is at a distance from the branching point of the overflow line in the overflow drain and steam exhaust tube. The steam valve can be positioned for example at the end of the steam exhaust tube, by way of which steam leaves the appliance. This end is also referred to in the following as the exit end. However according to the invention it is preferable for the steam valve to be positioned in the region between the branching point and the exit end. The exit end of the steam exhaust tube can be located above the cooking space. The arrangement of the steam valve between the branching point and the exit end means that it can be disposed for example in the rear part of the steam cooking appliance, in particular behind the cooking space muffle. Provided in this region of the steam cooking appliance are further components of the steam cooking appliance, for example the water tank for the overflow, so there has to be a certain distance between the rear face of the cooking space muffle and the rear face of the steam cooking appliance. This distance can then be used as a space for locating the steam valve. Because the steam valve is disposed at a distance from the branching point, it is always possible to ensure the reliable removal of surplus water from the cooking space, exiting by way of the overflow opening, regardless of the state of the steam valve.

The steam exhaust tube is preferably formed by a hose at least in the region of the at least one steam valve. A hose refers to a tubular body made of flexible material. A silicone hose can be used for example. The steam exhaust tube can consist of a hose in its entirety. This means that the entire section from the branching point to the exit end is formed by a hose. It is however also possible to form the steam exhaust tube by means of tubes, for example metal tubes or plastic tubes, in some regions and only to use a hose section in the region of the steam valve, for example using hose clamps or other hose connectors. Because the steam exhaust tube is formed by a hose in the region of the steam valve, the change to the cross section in this region can be brought about by changing the shape of the hose. The provision of separate facilities, which extend for example into the cross section of the tube, is not necessary here. The structure of the steam valve is therefore simple.

The steam valve preferably acts on the steam exhaust tube from the outside. In particular in the case of a steam exhaust tube that consists of a hose in the region of the steam valve, the steam valve preferably acts in at least one radial direction on the hose. Because the steam valve acts on the hose from the outside, a flow loss, which would be expected when closing elements are disposed in the tube even when the valve is in the opened state, are avoided. The inventive steam valve can also be referred to as a pinch valve. An arrangement of the valve outside the steam exhaust tube is also advantageous for maintenance purposes, as the valve can be accessed easily and any work required can be carried out without having to damage, in particular open, the steam exhaust tube.

The steam valve can comprise a mechanical actuation apparatus. A mechanical actuation apparatus refers to an actuation apparatus which is displaced or moved mechanically at least to some degree, thereby acting on the cross section of the steam exhaust tube. The use of a mechanical actuation apparatus is advantageous, as large forces can be applied by such an actuation apparatus and the shape of a hose can therefore be changed reliably, in particular by compression.

The steam valve preferably comprises a control element, in particular an electromagnetic or electric actuator or a thermoactuator. An electromagnetic or electric actuator here refers to an actuator, with which part of the steam valve, in particular the actuation apparatus, is moved by electromagnetic or electric drive. A thermoactuator refers to an actuator, with which part of the steam valve is moved by expanding or contracting a material as a result of temperature changes. It is particularly preferable for a thermoactuator to be used, in which a wax mass is provided, which expands or contracts depending on the prevailing temperature, thereby moving, in particular displacing, part of the steam valve. The use of such a thermoactuator has the advantage that it can apply large forces. Also the costs of such a thermoactuator are low. The use of a thermoactuator is possible with the present invention, despite the relatively sluggish response of the actuator, as the inventive structure means that there is no risk due to overpressure in the cooking space. If the steam valve is closed and cannot be opened quickly enough or far enough, steam can escape by way of the overflow drain.

At least one ventilation valve is preferably disposed on the cooking space, being at a distance from the overflow opening. The provision of a ventilation valve, which can also be referred to as a fresh air valve, means that it is possible to introduce fresh air into the cooking space in a specific manner. Because the ventilation valve is a separate apparatus from the steam valve, they can be activated differently and therefore set different conditions in the cooking space. The ventilation valve and therefore also the ventilation opening provided for ventilation purposes are also located in a position in the cooking space which is at a distance from the overflow opening. For example the ventilation opening can be provided on the upper face of the cooking space, in particular of the cooking space muffle. The ventilation valve here is disposed outside the cooking space on the ventilation opening. This position of the ventilation valve at a distance from the overflow opening is particularly advantageous as thorough mixing of the air can be achieved when the cooking space cools down. Before the user opens the door of a steam cooking appliance, the steam in the cooking space must be cooled, in particular to avoid burns. This is generally achieved by introducing fresh water, causing the steam to condense. However an underpressure results in the cooking space during condensing and cooling. By providing the ventilation valve at a distance from the overflow opening this underpressure can be equalized by introducing fresh air. At the same time steam, which has not condensed, can pass by way of the overflow opening to the steam exhaust tube. In this state the steam valve is preferably open so that the steam can be removed from the appliance. In the inventive steam cooking appliance the ventilation valve preferably remains open even when the steam cooking appliance is turned off, to ensure the circulation of air in the cooking space.

According to one embodiment the overflow drain ends in a water tank. This embodiment can prevent steam escaping in an unwanted manner during the steam cooking process. The overpressure that prevails in the cooking space during cooking is relatively low so that an escape of steam counter to the pressure of the water in the water tank does not normally occur. Thus in this embodiment of the inventive steam cooking appliance steam is removed reliably by way of the steam exhaust tube. The steam exhaust tube preferably ends above the cooking space. This allows the exiting steam to be emitted easily to the environment or to an extraction tube by way of openings in a housing wall.

According to one preferred embodiment the steam valve and the ventilation valve are connected to a control unit. Because these two facilities are activated by way of a single control unit, the states can be matched to one another. For example during cooling of the cooking space, the so-called condensation process, the ventilation valve can be set so that fresh air can pass by way of it into the cooking space, while the steam valve can be opened slightly to ensure the escape of steam that is still present and bring about the circulation of air in the cooking space.

The invention is described again below with reference to the accompanying drawings, in which:

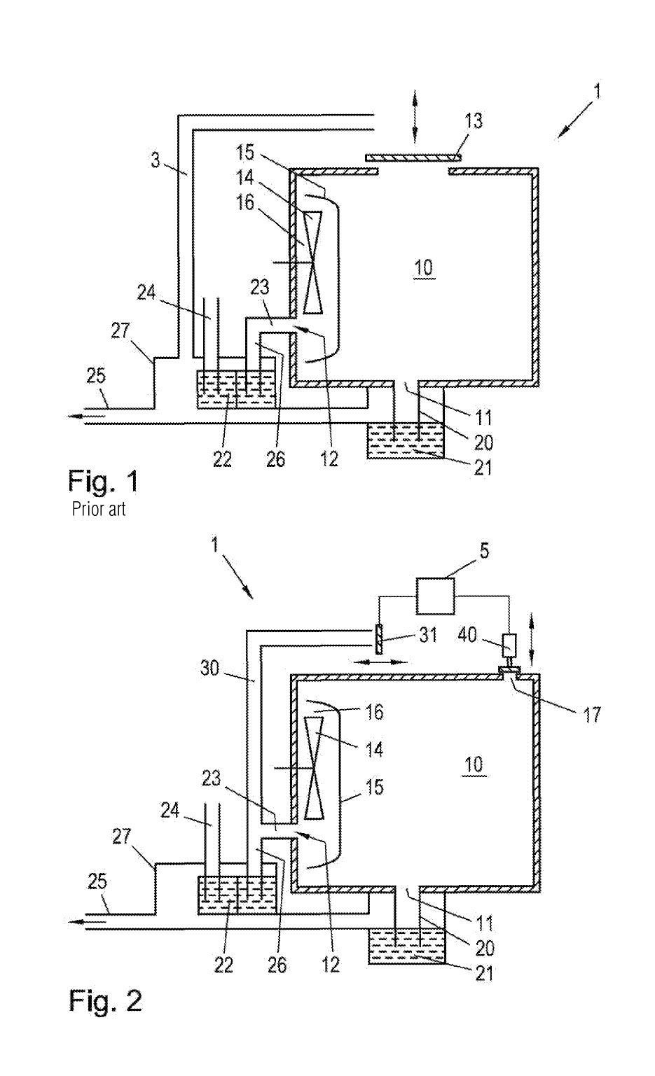

FIG. 1 shows a schematic diagram of the structure of a steam cooking appliance according to the prior art;

FIG. 2 shows a schematic diagram of the structure of an inventive embodiment of the steam cooking appliance invention;

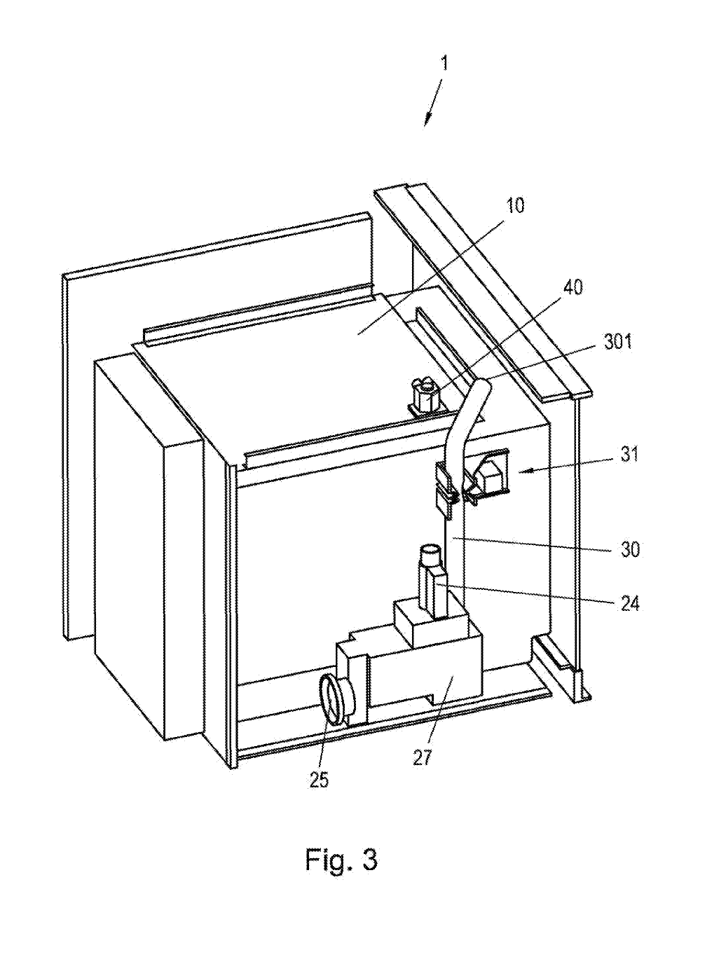

FIG. 3 shows a schematic perspective view of an embodiment of the inventive steam cooking appliance;

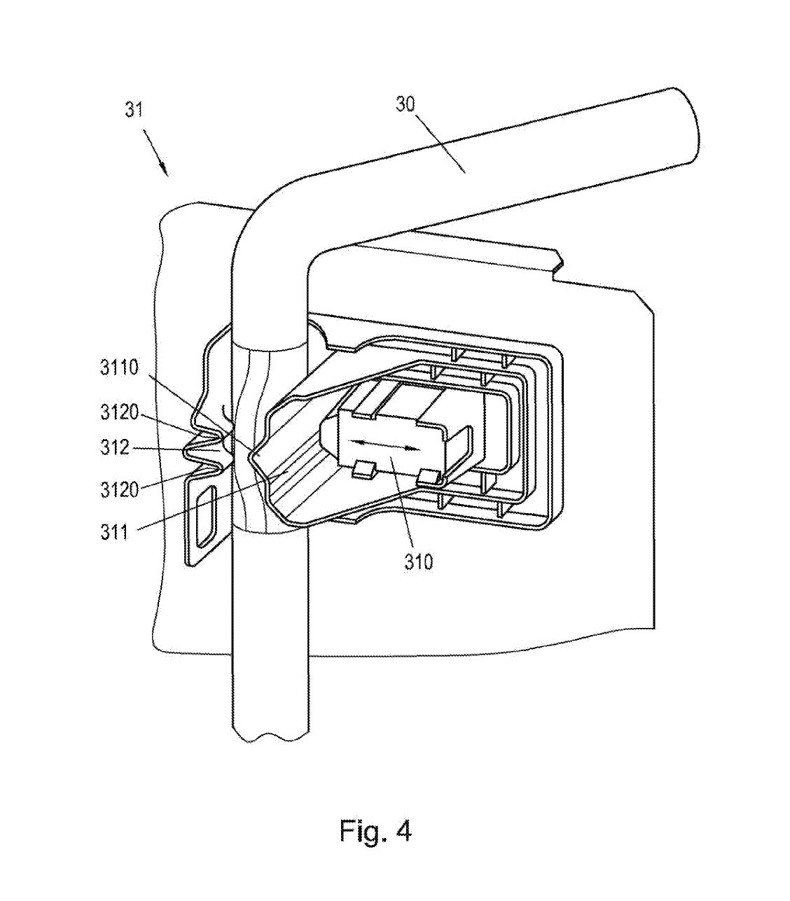

FIG. 4 shows a schematic perspective view of an inventive embodiment of a steam valve on a steam exhaust tube;

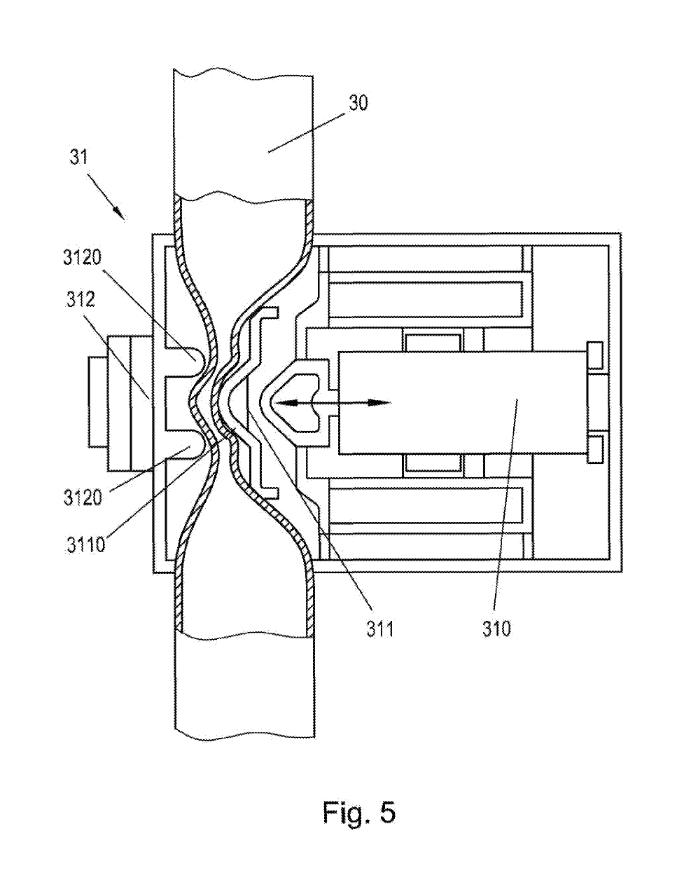

FIG. 5 shows a schematic sectional view of an inventive embodiment of the steam valve on a steam exhaust tube; and

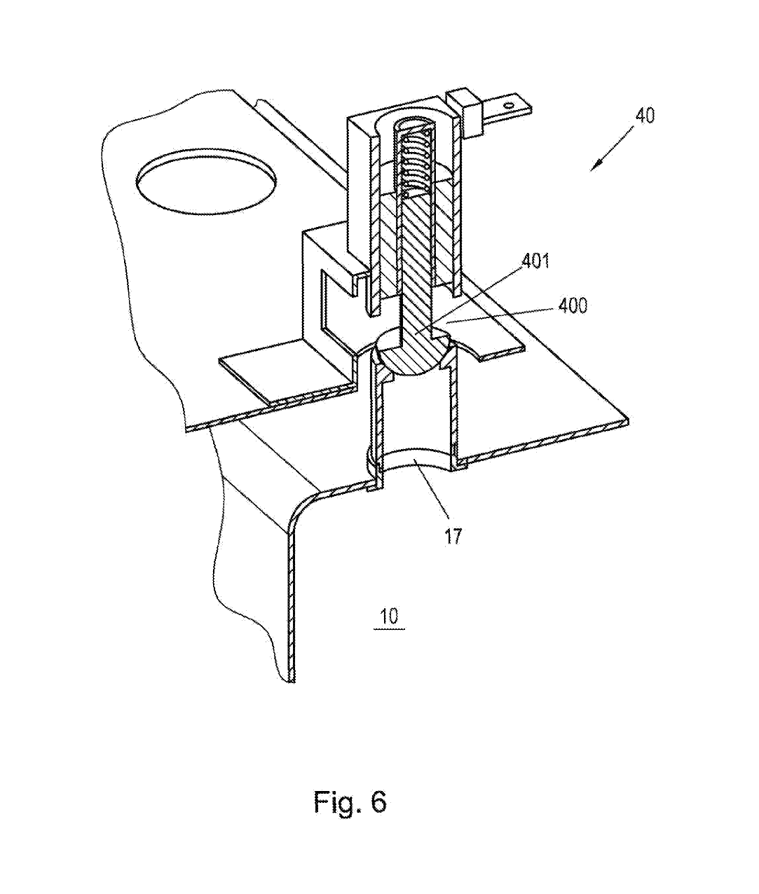

FIG. 6 shows a schematic perspective sectional view of a ventilation valve of a steam cooking appliance according to one embodiment of the present invention.

FIG. 1 shows an embodiment of a steam cooking appliance 1 according to the prior art. The steam cooking appliance 1 comprises a cooking space 10, which is generally formed by a cooking space muffle and is closed off at the front by a door (not shown). Provided on the floor of the cooking space 10 is a water drain opening 11, by way of which condensed water can pass out of the cooking space 10 into a collector 21 by way of a drain tube 20. Provided on the upper face of the cooking space 10 is a metal plate 13 that can be raised and covers an opening in the upper face of the cooking space 10 by way of a seal. Provided in the metal flap is a further, small opening (not shown), which is always open and by way of which fresh air can therefore enter the cooking space 10. Provided in the rear region of the cooking space 10 is an air baffle 15, which separates off a fan compartment 16. A fan 14 is disposed in the fan compartment 16.

Provided in the rear wall of the cooking space, which is one of the side walls of the cooking space or of the cooking space muffle, in the lower region is an overflow opening 12. Connected to the overflow opening 12 is an overflow line 23, which transitions into an overflow drain 26. The overflow drain 26 ends in a chamber of a water tank 22. A vent tube 24 leads out from the water tank 22. An overpressure in the water tank 22 can be equalized at least partially by way of the vent tube 24. Also provided on the water tank compartment 27, in which the water tank 22 is provided, is a steam chimney 3, by way of which steam can exit from the steam cooking appliance 1.

If steam is to be produced in the cooking space 10, the cooking space 10 must be closed. In this state the steam valve 13 on the cooking space 10 is closed. In this state steam can only escape from the cooking space 10 by way of the overflow opening 12. The overpressure in the cooking space 10 must be large enough here to overcome the counterpressure of the water in the water tank 22. The steam then passes from the water tank 22 into the compartment of the water tank 22 and leaves this by way of the steam chimney 3.

In the state in which cooking is to take place without steam, or to regenerate the air in the cooking space 10, in the illustrated embodiment of the cooking appliance 1 according to the prior art, fresh air is supplied by way of an opening (not shown) in the metal plate of the steam valve 13 and optionally also by raising the metal plate.

FIG. 2 shows an embodiment of the inventive steam cooking appliance 1.

The steam cooking appliance 1 comprises a cooking space 10, which is generally formed by a cooking space muffle and is closed off at the front by a door (not shown). Provided on the floor of the cooking space 10 is a water drain opening 11, by way of which condensed water can pass from the cooking space 10 into a collector 21 by way of a drain tube 20. The condensed water can be conducted out of the steam cooking appliance 1 from the collector 21 by way of the waste water outlet 25. Any overflowing water, which passes through the overflow opening 12, as described below, into a water tank 22, can also be conducted out of the steam cooking appliance 1 by way of the waste water outlet 25.

Provided in the rear region of the cooking space 10 is an air baffle 15, which separates off a fan compartment 16. A fan 14 is disposed in the fan compartment 16.

Provided in the rear wall of the cooking space 10 in the lower region is an overflow opening 12. Connected to the overflow opening 12 is an overflow line 23. The overflow line 23 branches. In particular the overflow line 23 transitions into an overflow drain 26 and a steam exhaust tube 26. The downward pointing overflow drain 26 ends in a chamber of a water tank 22. A vent tube 24 leads out from the water tank 22. An overpressure in the water tank 22 can be equalized at least partially by way of the vent tube 24. However with the inventive structure of the steam cooking appliance 1 there is no steam chimney 3 provided on the compartment of the water tank 22. Instead steam which escapes from the cooking space 10 will pass by way of the branching point in the overflow line 23 into the steam exhaust tube 30. The steam exhaust tube 30 extends from the branching point upward. Provided on the steam exhaust tube 30 is a steam valve 31. The steam valve 31 is only shown schematically in FIG. 2 and is described in more detail below with reference to FIGS. 4 and 5. Also provided on the upper face of the cooking space 10 is a ventilation apparatus in the form of a ventilation valve 40, which is also referred to as a fresh air valve. The ventilation valve 40 and the steam valve 31 are connected to a controller 5, by way of which the two valves 31, 40 can be activated.

FIG. 3 shows a schematic perspective rear view of an embodiment of the steam cooking appliance 1. In the view a section is cut out of an upper housing cover and a rear wall to show inside the upper face and rear face of the cooking space 10. Provided on the upper face of the cooking space 10 is a ventilation valve 40, which covers a ventilation opening 17 below it (see FIG. 2). The steam exhaust tube 30 extends along the rear face of the cooking space 10. It runs from the branching point of the overflow line (not visible) upward and is angled at the upper edge of the rear face so that the exit end 301 is located in the region above the cooking space 10. A steam valve 31 is fastened to the rear wall in the upper region of the rear wall of the cooking space. It is disposed in such a manner that a force can be applied to a hose region of the steam exhaust tube 30 parallel to the rear wall of the cooking space.

If cooking is to take place with steam in the cooking space 10, the steam valve 31 is closed. However if fresh air is required in the cooking space 10, it can be conducted into the cooking space 10 by way of the ventilation valve 40. In this state the steam valve 31 is preferably also open so that air can circulate in the cooking space 10.

One embodiment of a steam valve 31 is shown schematically in FIG. 4. In the region in which the steam valve 41 acts on it, the steam exhaust tube 30 consists of a hose, in particular a silicone hose, which can change shape. In the illustrated embodiment the steam valve 31 consists of two valve profiles 311, 312. One valve profile 311 is a plate with a leading edge 3110 configured thereon. The valve profile 311 is disposed in such a manner that the leading edge 3110 points in the direction of the steam exhaust tube 30. The further valve profile 312, which is also referred to as a counterprofile, also comprises a plate in the illustrated embodiment, with two spaced profile ribs 3120 extending therefrom. The valve profile 312 is disposed in such a manner that the profile ribs 3120 point toward the steam exhaust tube 30. The valve profile 312 is also disposed in such a manner that the leading edge 3110 of the first valve profile 311 is at a height between the parallel profile ribs 3120. The steam valve 31 also comprises an actuator 310. This is a thermoactuator. A rise in temperature causes wax or another material in the actuator to expand, displacing the valve profile 311 in the direction of the steam exhaust tube 30. When the actuator 310 is in the fully expanded state, as shown schematically in FIG. 5, the leading edge 3110, which projects between the profile ribs 3120, compresses the steam exhaust tube 30, thereby closing it completely.

FIG. 6 shows an embodiment of the ventilation valve 40 schematically. The ventilation valve 40 rests on the ventilation opening 17 of the cooking space 10. Provided in the ventilation valve 40 is a valve tappet 401, which can be moved in a vertical direction. In the embodiment shown in FIG. 6 the ventilation valve 40 is in the closed position. The valve tappet 401 rests on the valve seat, thereby closing the ventilation valve 40. When the valve tappet 401 is moved upward, air inlet openings 400, which are incorporated over the periphery of the ventilation valve 40, are exposed. Fresh air can then enter the cooking space 10 by way of said air inlet openings 400.

The present invention is not restricted to the illustrated embodiments. For example the structure of the steam valve can differ from the embodiment shown. The essence of the invention is that the steam valve is at a distance from the cooking space of the steam cooking appliance and is provided in a steam exhaust tube connected to the overflow opening. The steam valve must also be embodied such that opening and closing can be controlled; in other words the steam flow through the steam exhaust tube can be set and in particular can be regulated specifically.

The present invention simplifies the concept of providing a steam valve on a steam cooking appliance, in that the steam valve is combined with a necessary overflow opening that has to be provided anyway and is also referred to as an evacuation opening. The use of a hose that can be pinched from the outside as a steam valve is also implemented.

The present invention has a number of advantages. The main advantage is the simplification of production of the steam oven cooking space, in that one opening is provided or used for combined functions, specifically steam evacuation and water drainage. Production can also be achieved at low cost. If the inlet for fresh air and the outlet for steam or hot air are different, optimum circulation of air is achieved with the inventive steam cooking appliance by the preferred arrangement of a steam valve and a ventilation valve.

### LIST OF REFERENCE CHARACTERS

1 Steam cooking appliance
10 Cooking space
11 Water drain opening
12 Overflow opening
13 Metal plate (prior art)
14 Fan
15 Air baffle
16 Fan compartment
17 Ventilation opening
20 Drain tube
21 Collector
22 Water tank
23 Overflow line
24 Vent tube
25 Waste water outlet
26 Overflow drain
27 Water tank compartment
3 Steam chimney
30 Steam exhaust tube
301 Exit end
31 Steam valve
310 Actuator
311 Valve profile
3110 Leading edge
312 Valve profile
3120 Profile ribs
40 Ventilation valve
400 Air inlet opening
401 Valve tappet
5 Controller

1-8. (canceled)

9. A steam cooking appliance, comprising:
side walls defining a cooking space, at least one of the side walls having at least one overflow opening;
an overflow line connected to the overflow opening and branching into an overflow drain and a steam exhaust tube; and
at least one steam valve provided on the steam exhaust tube and configured to change, at least temporarily, a cross section of the steam exhaust tube.

10. The steam cooking appliance of claim 9, constructed in the form of a steam oven.

11. The steam cooking appliance of claim 9, wherein the steam valve is disposed at a distance from a branching point of the overflow line into the overflow drain and the steam exhaust tube.

12. The steam cooking appliance of claim 9, wherein the steam exhaust tube is formed by a hose at least in a region of the at least one steam valve.

13. The steam cooking appliance of claim 9, wherein the steam valve acts on the steam exhaust tube from outside.

14. The steam cooking appliance of claim 9, wherein the steam valve comprises a control element for actuation of the steam valve.

15. The steam cooking appliance of claim 14, wherein the control element is an electromagnetic actuator or a thermoactuator.

16. The steam cooking appliance of claim 9, further comprising at least one ventilation valve disposed on the cooking space at a distance from the overflow opening.

17. The steam cooking appliance of claim 9, further comprising a water tank, said overflow drain configured to end in the water tank.

18. The steam cooking appliance of claim 16, further comprising a control unit, said steam valve and said ventilation valve being connected to the control unit.
